(19) United States
(12) Patent Application Publication
(10) Pub. No.: US 2025/0180392 A1
(43) Pub. Date: Jun. 5, 2025

(54) FILL-LEVEL METER

(71) Applicant: Endress+Hauser SE+Co. KG, Maulburg (DE)

(72) Inventors: Markus Vogel, Schopfheim (DE); Ghislain Daufeld, Village Neuf (FR); Alexey Malinovskiy, Maulburg (DE); Steffen Markoni, Rheinfelden (DE); Markus Ziegler, Lörrach (DE)

(21) Appl. No.: 18/843,529

(22) PCT Filed: Feb. 20, 2023
(86) PCT No.: PCT/EP2023/054239

§ 371 Date: Sep. 3, 2024

(30) Foreign Application Priority Data
Mar. 4, 2022 (DE) 10 2022 105 197.8

(51) Int. Cl. G01F 23/284

(52) U.S. Cl. CPC G01F 23/284

(57) ABSTRACT

An FMCW-based fill-level meter comprises a signal generating unit for generating the ramp-shaped signal; an antenna for transmitting the signals towards the contents and for receiving the corresponding received signal; a signal processing unit which generates a frequency spectrum of the analysis signal per measurement cycle according to the FMCW principle; and a control/analysis unit to determine the distance using the frequency spectrum. The fill-level meter is characterized in that a frequency band and a measurement range can be specified, and on the basis thereon the fill-level meter can autonomously set or change the threshold frequencies and/or the ramp gradient. This is advantageous is that the use location of the fill-level meter is not limited to specific regions, such as China, the USA, or Europe, after being manufactured.

The invention relates to a radar-based fill-level meter which can be individually adapted with regard to its frequency band.

In process automation, corresponding field devices are used for capturing relevant process parameters. For the purpose of capturing the different process parameters, suitable measuring principles are therefore implemented in the corresponding field devices, in order to capture as process parameters, for example, a fill level, a flow, a pressure, a temperature, a pH value, a redox potential, or a conductivity. The Endress+Hauser corporate group manufactures and distributes a wide variety of field devices.

For measuring the fill level of contents in containers, contactless measuring methods have become established, because they are robust and require minimum maintenance. A further advantage of contactless measuring methods consists in the ability to be able to measure the fill level quasi-continuously. Radar-based measuring methods are therefore predominantly used in the field of continuous fill-level measurement (in the context of this patent application, “radar” refers to signals or electromagnetic waves with frequencies between 0.03 GHz and 300 GHz). In principle, the higher the measurement resolution that can be achieved, the higher the frequency. The pulse transit time method and FMCW (“frequency modulated continuous wave”) have become established as measurement methods. Radar-based fill-level measurement is described in greater detail in “Radar Level Detection, Peter Devine, 2000,” for example.

Typical frequency bands approved for radar-based level measurement are 26 GHZ, 60 GHz, 80 GHZ, and 120 GHZ, and increasingly also 180 GHz and 240 GHz. The exact location of the frequency band and its coverage depend upon the respective country or the exact measuring location at which the fill-level meter is used; in the case of 80 GHz, the corresponding frequency band in Europe is 76-84 GHZ, for example, while in Canada, it is 77-81 GHz. The measurement range that the fill-level meter must cover depends in turn upon the container in which the fill level is to be determined. Accordingly, the required measurement range that the fill-level meter must cover is limited to 15 m for smaller containers, while it can be up to 100 m for larger applications.

The functional principle of FMCW is based upon emitting a radar signal with a ramp-like changing frequency in the direction of the contents. After reflection from the surface of the contents, the corresponding received signal is mixed by signal engineering with the generated radar signal to obtain a low-frequency intermediate frequency signal. The frequency of the intermediate frequency signal represents the distance to the contents or the fill level. However, due to the presetting of the threshold frequencies, it is no longer possible to adapt the fill-level meter to new measuring conditions. Within the desired frequency band, the frequency of the emitted radar signal has a defined lower or upper threshold frequency and a defined ramp gradient, which are adjusted in advance during production to the later site of use or the later measurement range. However, due to the presetting of these parameters, it is no longer possible to subsequently adapt the fill-level meter to different measuring environments or different measuring conditions. The invention is therefore based upon the object of providing a radar-based fill-level meter which overcomes these disadvantages.

The invention achieves this object by an FMCW radar-based distance meter for measuring a distance to an object, which comprises the following components:
a signal generating unit that is designed to cyclically generate an electrical high-frequency signal whose frequency between a lower threshold frequency and an upper threshold frequency has a frequency ramp over time with a defined ramp gradient and a defined ramp duration,
an antenna, by means of which the radio-frequency signal can be emitted as a radar signal in the direction of the object and can be received as a corresponding received signal after reflection on the object, and
a signal processing unit, with
   a mixer stage that is designed to generate a low-frequency intermediate frequency signal per measurement cycle, based upon the electrical high-frequency signal and the received signal, according to the FMCW principle,
   a transformer stage that is designed to create a frequency spectrum of the analysis signal per measurement cycle, and
a control/analysis unit is designed to determine the distance using the frequency spectrum.

The distance meter according to the invention is characterized in that the desired frequency band and the desired measurement range can be specified for the signal generating unit. As a result, the control/analysis unit can control the signal generating unit according to the invention in such a way that the threshold frequencies and/or the ramp gradient are set as a function of the specified frequency band and the measurement range.

The advantage of this is that the site of use of the distance meter is not limited to a specific region. This also simplifies the logistics in manufacturing the distance meter. It is therefore particularly suitable to use the distance meter according to the invention to measure a fill level of contents in a container.

If at least the ramp duration of the frequency ramp is preset in the signal generating unit, the signal generating unit can, according to the invention, set the threshold frequencies to

$${f}_{stop} - {f}_{start} = Δ f$$

provided that the ramp gradient f′ is set according to

$${f}^{′} \leq {{f}^{′}}_{max} = Δ f * \frac{c}{2 h}$$

below a maximum ramp gradient (f′ₘₐₓ). In the other case, the threshold frequencies should be set according to the formula

$${f}_{stop} - {f}_{start} = Δ f * \frac{τ c}{2 h}$$

where the difference between the threshold frequencies (fₛₜₒₚ−fₛₜₐᵣₜ) is set smaller than the specified frequency band Δf. Both threshold frequencies fₛₜₒₚ and fₛₜₐᵣₜ must lie within the frequency band Δf.

If the distance meter according to the invention comprises an analog/digital converter stage which digitizes the intermediate frequency signal in the signal direction before the transformer stage, and if the distance meter comprises an IIR or FIR filter with an integrated decimator, arranged in the signal direction after the analog/digital converter stage, which subjects the digitized intermediate frequency signal to low-pass filtering, the distance meter according to the invention can be advantageously further developed: In this case, the control/analysis unit can be designed such that the decimation factor of the decimator is set in particular antiproportionally as a function of the ramp gradient or the measurement range.

In addition, the distance meter can be further developed so that the control/analysis unit includes a position sensor for determining the current site of use. This allows the signal generating unit to independently set or change the threshold frequencies and ramp duration depending upon the determined location. The position sensor can, for example, be a GPS module, a WLAN module, and/or a GSM module.

Distance meter Alternatively or additionally, the signal generating unit can be assigned an input unit by means of which the threshold frequencies can be manually set or changed at the respective site of use.

In the context of the invention, the term “unit” is understood in principle to mean a separate arrangement or encapsulation of the electronic circuits that are provided for a specific application—for example, for high-frequency signal processing or as an interface.

Depending upon the application, the corresponding unit may therefore comprise corresponding analog circuits for generating or processing corresponding analog signals. However, the unit can also comprise digital circuits, such as FPGA's, microcontrollers, or storage media in conjunction with appropriate programs. The program is designed to carry out the required method steps or to apply the necessary computing operations. In this context, different electronic circuits of the unit in the sense of the invention can also potentially access a common physical memory or be operated by means of the same physical digital circuit. In this case, it does not matter whether different electronic circuits within the unit are arranged on a common printed circuit board, or on multiple, interconnected printed circuit boards.

The invention is explained in more detail on the basis of the following figures. In the figures:

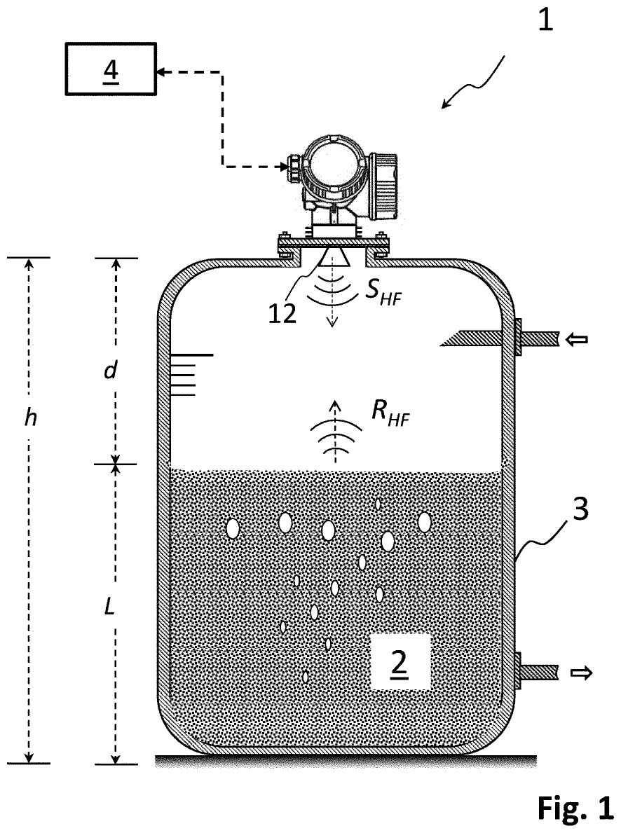

FIG. 1 shows a radar-based fill-level meter on a container,

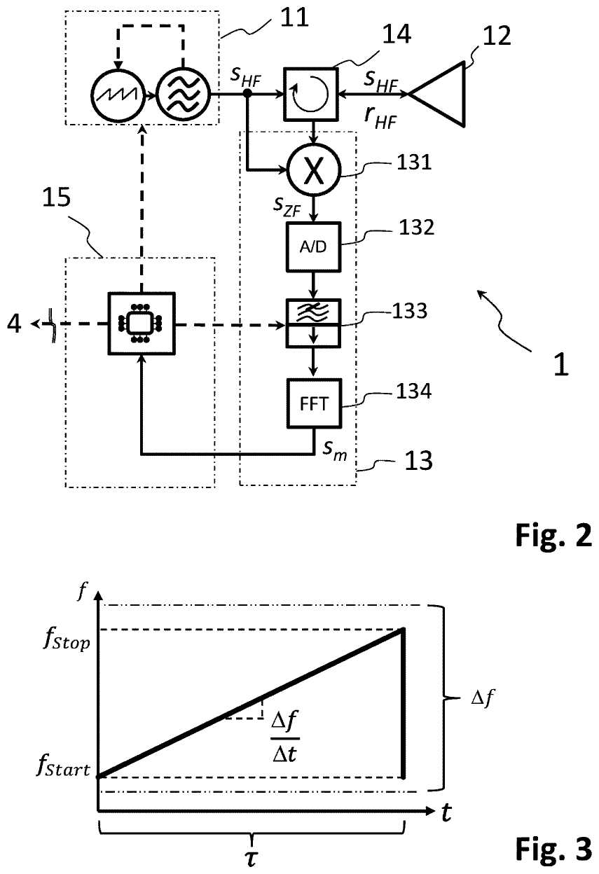

FIG. 2 shows a possible design variant of the antenna arrangement, and

FIG. 3 shows a schematic representation of an FMCW-typical frequency ramp.

For basic understanding, FIG. 1 shows a container 3 with contents 2, the fill level L of which is to be determined. The container 3 can be up to more than 100 m high, depending upon the type of contents 2 and field of application. The conditions in the container 3 are also dependent upon the type of contents 2 and the field of application. In the case of exothermic reactions, for example, high temperature and pressure stresses can occur. In the case of dust-containing or flammable substances, appropriate explosion protection conditions must be observed in the container interior.

To be able to determine the fill level L independently of the prevailing conditions, a fill-level meter 1 operating according to the FMCW principle is installed above the contents 2 at a known installation height h above the floor of the container 3. The fill-level meter 1 is attached and aligned in such a pressure- and media-tight manner to a corresponding opening of the container 3 that only the antenna 12 of the fill-level meter 1 is directed vertically downwards into the container 3 towards the contents 2, while the other components of the fill-level meter 1 are arranged outside the container 3.

Radar signals S_{HF} are transmitted via the antenna 12 in the direction of the surface of the contents 2. According to the FMCW principle, the frequency of the radar signal S_{HF} is changed over time in a ramp-like manner between a lower threshold frequency fₛₜₐᵣₜ and an upper threshold frequency fₛₜₒₚ per measurement cycle. The threshold frequencies fₛₜₐᵣₜ, fₛₜₒₚ are based in this case upon a frequency band Δf specified during production.

After reflection of the radar signal S_{HF} on the contents surface, the fill-level meter 1 receives the reflected radar signals R_{HF} again via the antenna 12. The resulting signal propagation time t between transmission and reception of the corresponding radar signals S_{HF}, R_{HF} is, according to

$$t = \frac{2 * d}{c} ,$$

correspondingly proportional to the distance d between the fill-level meter 1 and the contents 2, wherein c is the radar propagation speed of the particular speed of light. The signal propagation time t can be determined by the fill-level meter 1 using the FMCW method indirectly from the received signal R_{HF}, as explained with reference to FIG. 2. For example, based upon a corresponding calibration, the fill-level meter 1 can assign the measured propagation time t to the particular distance d. In this way, the fill-level meter 1 can, according to

$$d = h - L ,$$

in turn determine the fill level L, provided the installation height h is stored in the fill-level meter 1.

In general, the control/analysis unit of the fill-level meter 1 is connected to a superordinate unit 4, such as a local process control system or a decentralized server system, via a separate interface unit such as “4-20 mA,” “PROFIBUS,” “HART,” or “Ethernet.” In this way, the measured fill-level value L can be transmitted, for example, in order to control the flow to or discharge from the container 3 if necessary. However, other information about the general operating state of the fill-level meter 1 can also be communicated.

The circuit layout of the fill-level meter 1 is shown in FIG. 1: Accordingly, the radar signal S_{HF} to be transmitted is generated as an electrical high-frequency signal S_{HF} in a signal generating unit 11, which in the shown embodiment is based upon a phase-controlled control loop (known primarily in English as a “phase locked loop, PLL”). The high-frequency signal S_{HF} is generated according to the FMCW principle with a corresponding ramp-shaped frequency change. The high-frequency signal S_{HF} is then fed via a transmit/receive switch 14 to the antenna 12, from where the high-frequency signal SHE is transmitted as a radar signal S_{HF}. The transmit/receive switch 14 can be designed, for example, as a diplexer or as a duplexer.

The corresponding received signal r_{HF} received by the antenna 12 is first fed to a mixer stage 131 via the signal switch 14 in a signal processing unit 13 of the fill-level meter 1. There, the received signal r_{HF} is mixed with the high-frequency signal S_{HF} generated by the signal generating unit 11, whereby a low-frequency intermediate frequency signal S_{ZF} is generated according to the FMCW principle.

By means of an analog/digital converter stage 132, the intermediate frequency signal S_{ZF} is time- or value-discretized in the signal direction downstream of the mixer stage 131, so that a transformer stage 134 can create a frequency spectrum sₘ from it with little computational effort. A digital low-pass filter stage 133 can optionally be arranged, in the signal direction downstream of the analog/digital converter stage 132, in order to filter out any noise and other interference. From the frequency spectrum sₘ, the control/analysis unit 15 can determine the maximum which can be assigned to the reflection on the contents 2 in order to use this to determine the distance d or the fill level L.

FIG. 3 shows the linear frequency change over time of the high-frequency or radar signal S_{HF}, S_{HF} in the form of a ramp, typical for FMCW, as generated by the signal generating unit 11 per measurement cycle: The frequency ramp is characterized by a ramp duration T, a ramp gradient f′, and a lower threshold frequency fₛₜₐᵣₜ as well as an upper threshold frequency fₛₜₒₚ, wherein the threshold frequencies fₛₜₐᵣₜ, fₛₜₒₚ, depending upon the selection of the respective frequency band Δf, do not have to coincide with its limits, but may be within the frequency band Δf. These parameters are related according to

$${f}^{′} = \frac{Δ f}{τ} .$$

According to the invention, the desired frequency band Δf can be specified for the fill-level meter 1 even after its completion, e.g., via an input mask of the control/analysis unit 15, or indirectly via the higher-level unit 4. As shown in FIG. 2, the control/analysis unit 15 correspondingly controls the signal generating unit 11. In addition, the desired measurement range of the fill-level meter 1 can be adjusted manually or automatically. This can also be done, for example, via the operating and input mask, or indirectly via the higher-level unit 4. The measurement range must be set so that at least the installation height h is recorded.

In contrast to the measurement range and the frequency band Δf, it is advantageous to preset the ramp duration T of the frequency ramp in the signal generating unit 11 to a defined value due to the upwardly limited sampling frequency of the analog/digital converter 132. The value of the ramp duration T is chosen taking into account the required computing power, the necessary storage capacity, and the available energy. Under these boundary conditions, the fill-level meter 1 automatically sets the ramp gradient f′ after the entry of the measuring range h and the frequency band Δf according to

$${f}^{′} = \frac{{f}_{stop} - {f}_{start}}{τ} .$$

The ramp gradient f′ is limited according to

$${f}^{′} \leq {{f}^{′}}_{max} = Δ f * \frac{c}{2 h}$$

by the previously selected measurement range. Accordingly, the fill-level meter 1 sets the threshold frequencies fₛₜₐᵣₜ, fₛₜₒₚ according to

$${f}_{stop} - {f}_{start} = Δ f$$

provided that the selected frequency band Δf is not so broad that the maximum ramp gradient f′ₘₐₓ is thereby exceeded. In the other case, the threshold frequencies fₛₜₐᵣₜ, fₛₜₒₚ within the frequency band Δf are limited according to

$${f}_{stop} - {f}_{start} = Δ f * \frac{τ c}{2 h} ,$$

as shown in FIG. 3.

Automatically setting or changing the frequency band Δf and the measurement range h if required can be implemented by storing an assignment table in the control/analysis unit 15. The table assigns different regions to the frequency band Δf of the respective region as a potential site of use. In this case, by means of a position sensor implemented in the control/analysis unit 15, it can be determined in which region the current site of use of the fill-level meter 1 is located. Based upon the current region, the fill-level meter 1 can accordingly assign the corresponding frequency band Δf using the table. As an alternative to a position sensor, it is also conceivable that the fill-level meter 1 according to the invention determine its current position and therefore the respective region by contact with a possible mobile radio or WLAN network. For this purpose, the fill-level meter 1 must comprise a corresponding GSM or WLAN module.

### LIST OF REFERENCE SIGNS

1 Fill-Level Meter
2 Contents
3 Container
4 Higher-level unit
11 Signal-generating unit
12 Antenna
13 Signal processing unit
14 Transmitting/receiving switch
15 Control/analysis unit
131 Mixer stage
132 Analog/digital converter stage
133 Low-pass filter stage
134 Transformer stage
f_{start, stop} Threshold frequencies
C Radar propagation speed
d Distance, separating distance
h Installation height
L Fill level
r_{HF} Received signal
S_{HF} Radar signal
sₘ Frequency spectrum
S_{HF} Electrical radio-frequency signal
S_{ZF} Intermediate frequency signal
Δf Frequency band
f′, f′ₘₐₓ (Maximum) ramp gradient
T, Tₘₐₓ (Maximum) ramp duration

1-10. (canceled)

11. A frequency modulated continuous wave (FMCW) radar-based distance meter for measuring a distance to an object, comprising:
a signal generating unit which is designed to cyclically generate an electrical high-frequency signal whose frequency between a lower threshold frequency and an upper threshold frequency has a frequency ramp over time with a defined ramp gradient and a defined ramp duration;
an antenna by which the radio-frequency signal can be emitted as a radar signal in a direction of the object and can be received as a corresponding received signal after reflection on the object;
a signal processing unit (13), including:
a mixer stage that is designed to generate a low-frequency intermediate frequency signal per measurement cycle based upon the electrical high-frequency signal and the received signal (THF), according to the FMCW principle, and a transformer stage that is designed to create a frequency spectrum of the intermediate frequency signal per measurement cycle; and
a control/analysis unit is designed to determine the distance using the frequency spectrum,
wherein a frequency band and a measurement range can be specified for the signal generating unit, and
wherein the control/analysis unit is configured to control the signal generating unit such that the threshold frequencies and/or the ramp gradient are set as a function of the specified frequency band and the measurement range.

12. The FMCW radar-based distance meter according to claim 11,
wherein a ramp duration of the frequency ramp is preset in the signal generating unit.

13. The FMCW radar-based distance meter according to claim 12,
wherein the signal generating unit sets the threshold frequencies according to
$${f}_{stop} - {f}_{start} = Δ f$$
provided that the ramp gradient, according to
$${f}^{′} \leq {{f}^{′}}_{max} = Δ f * \frac{c}{2 h} ,$$
is below a maximum ramp gradient.

14. The FMCW radar-based distance meter according to claim 11, further comprising:
an analog/digital converter stage which is designed to digitize the intermediate frequency signal in the signal direction before the transformer stage.

15. The FMCW radar-based distance meter according to claim 14, further comprising:
a low-pass filter stage that is arranged in the signal direction downstream of the analog/digital converter stage and that is designed to subject the digitized intermediate frequency signal to low-pass filtering.

16. The FMCW radar-based distance meter according to claim 15, wherein the low-pass filter stage is designed as an infinite impulse response (IIR) or a finite impulse response (FIR) filter with an integrated decimator, and wherein the control/analysis unit is designed to set a decimation factor of the low-pass filter stage as a function of the ramp gradient or the measurement range.

17. The FMCW radar-based distance meter according to claim 12,
wherein the control/analysis unit comprises a position sensor via which a current site of use of the distance meter can be determined, and
wherein the control/analysis unit is designed to set or change the threshold frequencies and the ramp duration in the signal generating unit depending upon the determined site of use.

18. The FMCW radar-based distance meter according to claim 17, wherein the position sensor includes a GPS module, a WLAN module, and/or a GSM module via which the site of use can be determined.

19. The FMCW radar-based distance meter according to claim 11, wherein the signal generating unit is assigned an input unit by means of which the threshold frequencies can be manually set or changed.
